(19) United States
(12) Patent Application Publication
(10) Pub. No.: US 2004/0056158 A1
(43) Pub. Date: Mar. 25, 2004

(54) T-clip assembly

(76) Inventors: John W. Stuart, Chicago, IL (US); Curt J. Studebaker, Columbia City, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/247,985

(22) Filed: Sep. 20, 2002

(51) Int. Cl. F16M 13/00; F16L 3/08

(52) U.S. Cl. 248/74.2; 24/459

(57) ABSTRACT

The invention relates to a T-clip for a fitting having a T-branch, especially for T-fittings and Union fittings used in motor vehicles. The T-clip has a base with holders at opposite ends of the base and optionally an inner sidewall between the holders. Each holder has sidewalls which hold the legs of the fitting in place. The inner sidewall prevents the T-branch from over-rotation within the T-clip.

### BACKGROUND OF THE INVENTION

1. Field of the Invention

The present invention relates to a T-clip assembly used for fittings having T-branches, such as T-fittings or Union fittings, especially for fuel and air brake systems for motor vehicles.

2. Description of the Prior Art

Fittings with T-branches, T-fittings for example, are commonly used in motor vehicles for a variety of purposes, such as fluid systems, like the fuel system and the air braking system. T-fittings attach three cylindrical parts together and are in fluid communication with the fluid system. In a motor vehicle, a T-fitting can attach supply tubing from two tanks to a single tube leading to the engine. Similarly, a T-fitting attaches return tubing from the engine to return tubing to two tanks.

Fittings with T-branches have their own problems. A straight tubular fitting can use almost any type of clip, such as a spring hose clip. A T-fitting, however, has a T-branch located between two legs that prevents the use of most spring hose clips. Similarly, a Union fitting has two opposite T-branches between two legs that also precludes the use of most spring hose clips. Spring hose clips typically have long tall sidewalls. These long, tall sidewalls prevent using spring hose clips with a fitting having a T-branch. There is no place but out of the clip to fit the T-branch. The long sidewalls also make it more difficult to insert into and remove from these clips a tubular fitting, especially for wider diameter T-fittings.

Using a U-shaped clip with a short sidewall presents another problem. For a T-fitting, two U-shaped clips are required to be spaced apart to provide for the T-branch. The two clips must also align together to fit the legs of the T-fitting. Because the two separate clips do not work together cooperatively, it's more difficult to insert the T-fitting into the two clips. The two clips must also be installed separately, requiring more installation time.

Therefore, it would be advantageous to develop a T-clip that can effectively hold a fitting with T-branches to a bracket or other apparatus. A second advantage would be to have a T-clip that can hold a fitting with T-branches using only one clip. Another advantage of the invention would be to hold a curved or hexagonal fitting that locks tightly within the clip. Still another advantage would be to develop a clip that would allow the adjustment of the orientation of the T-fitting. Another advantage would be to develop a T-clip that can fit a number of different types and diameters of fittings with T-branches and not interfere with any of the fitting's threads.

### SUMMARY OF THE INVENTION

According to the invention, there is provided a T-clip having a base with holders at opposite ends of the base. The holders are aligned to jointly engage the arms of a fitting with T-branches. Each holder has a pair of sidewalls curving proximally from the base. A first portion of the sidewall curves laterally from the base and a second portion curves medially from the first portion. Each sidewall has shoulders that outwardly angle and extend along the length of the sidewall distal to the base.

In another embodiment of the invention, the T-clip has a base with holders on opposite ends of the base and a pair of inner sidewalls located between the holders. Each holder has a pair of sidewalls. The sidewalls form the sides and curve proximally from the base. The sidewalls also have a shoulder. A first portion curves laterally from the base and a second portion curves medially from the first portion. The shoulders are outwardly angled and extend along the length of the sidewall distal to the base.

The inner sidewalls extend from opposite sides of the base. The inner sidewalls also curve proximally from the base and have a first part that curves outwardly from the base.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a top perspective view of an embodiment of the invention;

FIG. 2 is a cross-sectional view of an embodiment of the invention shown in FIG. 1 along line a-a′;

FIG. 3 is a top plan view of an embodiment of the invention;

FIG. 4 is a partial side view of an embodiment of the invention with an inserted T-fitting;

FIG. 5 is a perspective view of an embodiment of the invention with an inserted T-fitting;

FIG. 6 is a top plan view of an embodiment of the invention with an inserted T-fitting;

FIG. 7 is a side perspective view of a bracket with an embodiment of the invention;

FIG. 8 is a side plan view of bracket with an embodiment of the invention with an inserted T-fitting;

FIG. 9 is a top perspective view of an embodiment of the invention;

FIG. 10 is a top plan view of an embodiment of the invention with an inserted Union fitting and the T-legs in phantom;

FIG. 11 is a side view of an embodiment of the invention with an inserted T-fitting and Union fitting; and

FIG. 12 is a top perspective view of another embodiment of the holder with a larger shoulder and more restricted opening.

### DETAILED DESCRIPTION OF THE INVENTION

Turning to the figures, where like reference numerals refer to like structures, T-clip 10 has base 12 and holders 42 located at opposite ends 40, 41 of base 12 on a face of base 12. First side 18 of base 12 is preferably planar, although it can be slightly curved if desired.

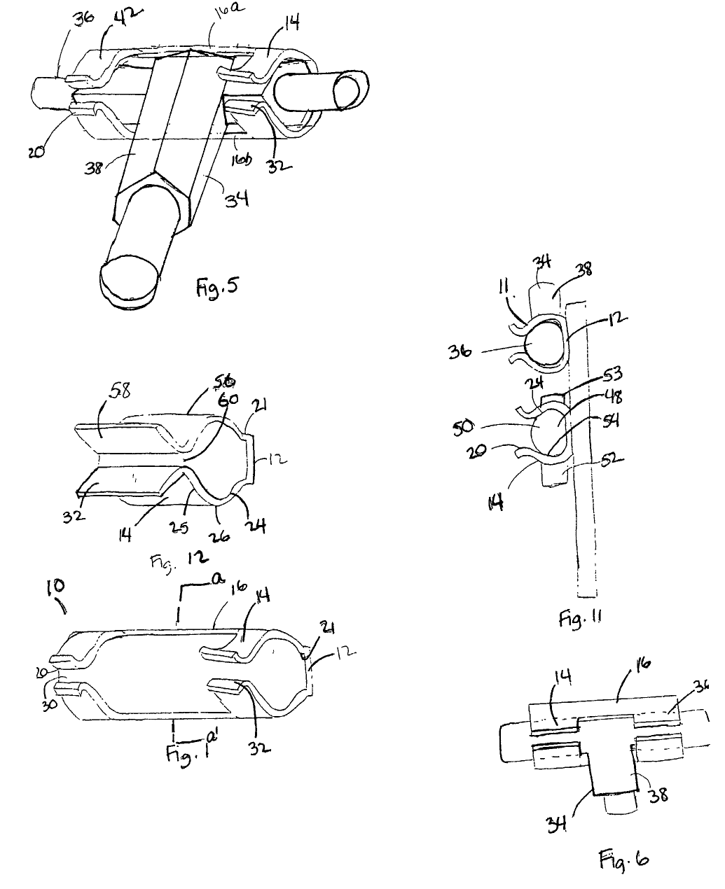

Each holder has a pair of sidewalls 14 that extend outwardly from first side 18 of base 12. As shown in FIGS. 1 and 2, sidewalls 14 can extend from outwardly projecting linear portion 21 of base 12. Outwardly angled shoulders 20 extend the length of sidewall 14 distal to base 12. Angled shoulders 20 slope laterally distal to base 12, and can form an angle 2 between the shoulders of greater than or equal to about 120°. The depth of angled shoulder 20 from curved section 22 to the tip can be relatively short (FIG. 2) or long (FIG. 12).

Curved section 22 curves proximally from base 12 toward shoulders 20. Curved section 22 has first 24 and second 25 curved portions. First portion 24 curves laterally to a maximum curvature 26. Second portion 25 curves medially from the maximum curvature 26.

Shoulders 20 of sidewall 14 form constricted opening 30, which is narrower than the width of leg 36 of T-fitting 34. The width of constricted opening 30 can be approximately the same width as base 12 or much narrower, if desired (FIG. 12).

Inner shoulder face 32 guides leg 36 into T-clip 10 with minimum force through opening 30. Sidewalls 14 lock legs 36 into T-clip 10. T-branch 38 fits between holders 42.

In the embodiment shown in FIGS. 1-4, inner sidewalls 16 are located between holders 42. Inner sidewalls 16 extend outwardly from first side 18 of base 12 at opposite sides 56, 57 of base 12. First part 28 of inner sidewall 16 curves outwardly from base 12. The height of inner sidewall 16 ranges from less than approximately ⅓ the height of sidewall 14 to approximately ⅔ the height of sidewall 14. The curvature of inner sidewall 16 preferably matches the curvature of sidewall 14. Therefore, inner sidewall 16 can reach a maximum curvature 27 and have a second part 29 curving medially from the maximum curvature to the height of inner sidewall 16.

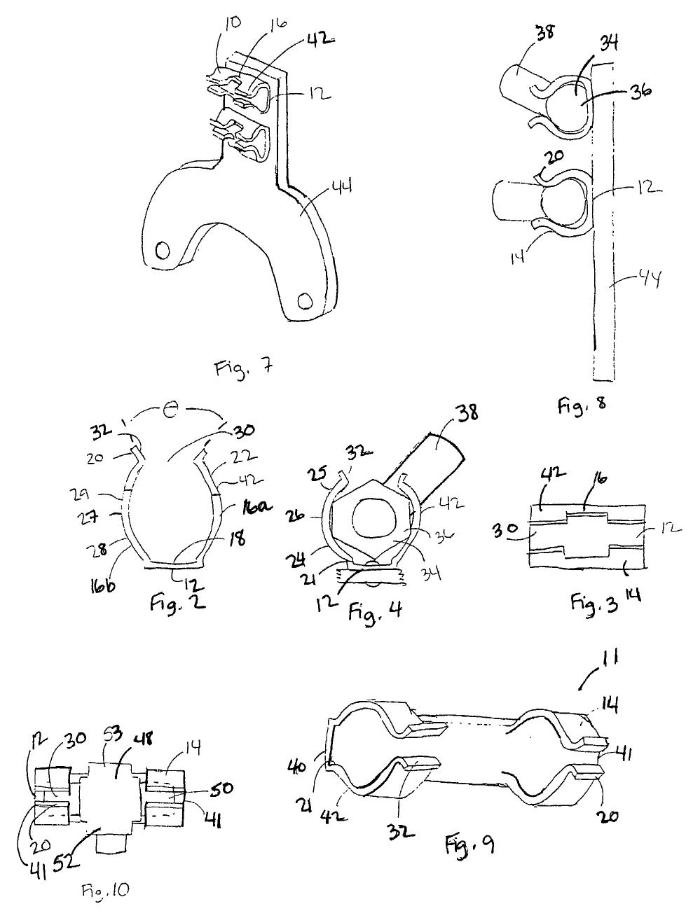

FIGS. 4 and 5 show legs 36 of T-fitting 34 in the T-clip 10. For illustrative purposes, leg 36 is hexagonal rather than round. Sidewalls 14 deflect laterally. For leg 36, sidewall 14 engages at least part of outer face 46 of leg 36 and holds leg 36 within holder 42. Second portion 24 deflects outwardly toward the maximum curvature. Second portion 24 frictionally engages at least part of leg 36 to hold leg 36 within T-clip 10. For a wider leg in the T-clip, sidewall 14 deflects farther laterally. Inner sidewall 16 frictionally engages T-fitting 34 opposite T-branch 38 and can also deflect laterally.

FIG. 6 shows this embodiment of the invention with another type of T-fitting. Holders 42 engage legs 36 while inner sidewall 16 frictionally engages the fitting opposite T-branch 38. T-branch 38 can rest on inner sidewall 16, if desired. T-branch 38 can also rotate between first inner sidewall 16a and second inner sidewall 16b. The height of inner sidewall 16, however, determines the degree of rotation allowed for T-branch 38 and can prevent the over-rotation of T-branch 38.

FIGS. 7 and 8 show another embodiment of T-clip 10. In this embodiment, sidewalls 14 do not have a linear portion between base 12 and curved portion 22. For illustrative purposes, FIG. 8 shows two different positions of T-fitting 34. One position is angled with T-branch flush against the inner sidewall. The second position shown is outward away from bracket 44.

Alternatively as shown by the embodiment in FIGS. 9-11, T-clip 11 has no inner sidewall. T-clip 11 has a base 12 and sidewalls 14 extending from first side 18 of base 12 and spaced apart at opposite ends 40, 41.

In this embodiment, legs 50 of Union fitting 48 insert between sidewalls 14 of both holders 42. By providing separated holders 42 for engaging a leg at opposite ends 40, 41 of base 12, T-clip 11 insures that an inserted Union fitting has at least two, spaced apart points of support. Legs 50 may rest flush against base 12.

Similarly, FIGS. 10 and 11 show Union fitting 48 in the T-clip 11 with holders 42. For illustrative purposes, FIG. 11 shows T-fitting 34 as well and legs are round. Sidewalls 14 deflect laterally. For leg 50, sidewall 14 touches at least a portion of outer face 54 and holds leg 50 against sidewalls 14. Second portion 24 deflects outwardly toward the maximum curvature. Second portion 24 frictionally engages at least part of leg 50 to hold leg 50 within T-clip 11. Opposite first 52 and second 53 T-branches fit between holders 42. Holders 42 lock Union fitting 48 within T-clip 11. If T-fitting 34 is used, T-branch 38 can rotate, if desired, to another position.

FIG. 12 illustrates holder 56 with longer shoulders 58. Holder 56 has a more constricted opening 60. In this configuration, holder 56 can be used for a larger size range of fittings. Constricted opening 60 can accommodate a larger range of leg diameters. Longer shoulders 58 can increase the ease of insertion of a fitting having legs with a larger diameter.

The T-clip attaches to a bracket or other apparatus using any fastening means that are known in the art. These means are typically screwing, bolting, riveting, chemically bonding, and the like.

The outward angle that the sidewall assumes under pressure from the leg makes it easier to remove the fitting from the T-clip without losing the frictional contact that prevents the fitting from falling from the T-clip during use.

The spacing between sidewalls allows the sidewalls to cooperatively hold fittings with T-branches in position. The maximum distance between the maximum curvature of the sidewalls is greater than the width of the largest leg that can fit within the T-clip.

A leg inserted into the T-clip at least partially contacts the adjacent faces of the cooperating sidewalls. The sidewalls flex independently under the mechanical stress of introducing a leg to allow each sidewall to make independent clean contact with the fitting.

The angled shoulders help guide the leg into and out of the T-clip. When inserting a T-fitting, for example, the user slides the T-fitting toward the base. The angled shoulders guide the leg through the opening toward the base. When using inner sidewalls, the inner sidewalls help lock the T-fitting within the T-clip while preventing the T-branch from over-rotating within the T-clip. When removing the T-fitting, the force the user exerts on the T-fitting enlarges the opening between the sidewalls as the sidewalls smoothly guide the legs through the openings and out of the T-clip.

The T-clip is made from material that is biased to return to its original shape and is preferably a unitary piece with all parts made from one material. Although the sidewalls move when the fitting is inserted into the T-clip, the material itself neither bends nor deforms around the leg of the fitting. The sidewalls and the base may act as a spring clamping a fitting into a T-clip. Steel, plastics, with or without fillers, and the like are suitable, with steel preferred.

The curved design of the holder allows one T-clip to be used with different sizes and types of fittings with T-branches. The curved design and opening allows fittings with narrow and wider legs and legs of different shapes, such as hexagonal or cylindrical, to use the same T-clip. If a number of different sizes of fittings are used for one T-clip, a more constricted opening may be desired to lock in the smaller sized legs. This reduces the need for multiple T-clips. Inventory expenses are also reduced because fewer T-clips are needed to be made and stored.

While the invention is shown in only one of its forms, it is not thus limited but is susceptible to various changes and modifications without departing from the spirit and scope of the invention.

What is claimed is:

1. A T-clip for a fitting having two legs and a T-branch, comprising:
a base having opposite ends;
first and second holders extending from the base and being located at opposite ends of the base and aligned to jointly engage the legs; and
a pair of sidewalls forming the sides of the holder and curving proximally from the base, each sidewall having an outwardly angled shoulder extending along the length of the sidewall distal to the base, a first portion of the sidewall curving outwardly from the base, and a second portion of the sidewall curving inwardly from the first portion.

2. The T-clip of claim 1, further comprising:
a constricted opening between the shoulders of the holder.

3. The T-clip of claim 2, wherein the sidewalls and the base act as a spring to clamp the legs into the holder.

4. The T-clip of claim 2, wherein the base has a linear portion projecting outwardly.

5. A T-clip for a fitting having two legs and a T-branch, comprising:
a base having opposite ends and opposite sides;
first and second holders extending from the base and being located at opposite ends of the base and aligned to jointly engage the legs;
a pair of sidewalls forming the sides of the holder and curving proximally from the base, each sidewall having an outwardly angled shoulder extending along the length of the sidewall distal to the base, a first portion of the sidewall curving outwardly from the base, and a second portion of the sidewall curving inwardly from the first portion toward the inner sidewall; and
a pair of inner sidewalls between the first holder and the second holder and curving proximally from the base at opposite sides of the base, the inner sidewalls having a first part curving outwardly from the base.

6. The T-clip of claim 5, further comprising:
a constricted opening between the shoulders of the holder.

7. The T-clip of claim 6, wherein the sidewalls and the base act as a spring to clamp the T-fitting into the holder.

8. The T-clip of claim 6, wherein the base has a linear portion projecting outwardly.

9. An apparatus for securing a fitting having two legs and a T-branch, comprising:
a support;
a T-clip comprising a base having opposite ends and opposite sides, and first and second holders extending from the base and being located at opposite ends of the base and aligned to jointly engage the legs;
a pair of sidewalls forming the sides of the holder and curving proximally from the base, each sidewall having an outwardly angled shoulder extending along the length of the sidewall distal to the base, a first portion of the sidewall curving outwardly from the base, and a second portion of the sidewall curving inwardly from the first portion; and
means for fastening the T-clip to the support.

10. The apparatus of claim 9, further comprising:
a constricted opening between the shoulders of the holder.

11. The apparatus of claim 10, wherein the sidewalls and the base act as a spring to clamp the shaft into the holder.

12. The apparatus of claim 10, further comprising:
a pair of inner sidewalls between the first holder and the second holder and extending from the base, the inner sidewalls curving proximally from the base and having a first part curving outwardly from the base, the inner sidewalls being located at opposite sides of the base.

13. The apparatus of claim 12, wherein the base has a linear portion projecting outwardly.

14. An apparatus for connecting tubing in a fluid system within a motor vehicle, comprising:
a support;
a fitting having two legs and a T-branch, the legs and T-branch being adapted to connect the tubing;
a T-clip comprising a base having opposite ends and opposite sides, and first and second holders extending from the base and being located at opposite ends of the base and aligned to jointly engage the legs;
a pair of sidewalls forming the sides of the holder and curving proximally from the base, each sidewall having an outwardly angled shoulder extending along the length of the sidewall distal to the base, a first portion of the sidewall curving outwardly from the base, and a second portion of the sidewall curving inwardly from the first portion, and wherein the sidewalls engage at least part of the legs to hold the legs within the holder; and
means for fastening the T-clip to the support.

15. The apparatus of claim 14, further comprising:
a constricted opening between the shoulders of the holder.

16. The apparatus of claim 15, wherein the sidewalls and the base act as a spring to clamp the shaft into the holder.

17. The apparatus of claim 15, further comprising:
a pair of inner sidewalls between the first holder and the second holder and extending from the base, the inner sidewalls curving proximally from the base and having a first part curving outwardly from the base, the inner sidewalls being located at opposite sides of the base.

18. The apparatus of claim 15, wherein the base has a linear portion projecting outwardly.
